(19) United States
(12) Patent Application Publication
(10) Pub. No.: US 2026/0141191 A1
(43) Pub. Date: May 21, 2026

(54) REDUCING DATA STORAGE DUPLICATION THROUGH A MULTI-AGENT NATURAL LANGUAGE PROCESSING LOOP

(71) Applicant: AT&T Intellectual Property I, L.P., Atlanta, GA (US)

(72) Inventors: Ayush Kumar, Malden, MA (US); Eshrat Huda, Hillsborough, NJ (US); Mukundan Sarukkai, Manalapan, NJ (US)

(21) Appl. No.: 18/954,508

(22) Filed: Nov. 20, 2024

(51) Int. Cl. G06F 40/58; G06F 40/42

(52) U.S. Cl. CPC G06F 40/58; G06F 40/42

(57) ABSTRACT

An example method includes identifying, using a first NLP agent, a database of an enterprise containing desired data, selecting, using a second NLP agent, a schema analysis tool that is believed to be suited to a type of the database, establishing, using a third NLP agent, a connection to the database, extracting, using a fourth NLP agent, schema information from the database, comparing, using a fifth NLP agent and the schema analysis tool and based on the schema information, a structure of a schema of the database to a structure of a schema of a similar database, determining, based on the comparing, a change to make to the schema of the database, sending, using a sixth NLP agent, an instruction to a network element of the enterprise to make the change to the schema of the database, and validating, using a seventh NLP agent, the change to the schema.

The present disclosure relates generally to artificial intelligence, and relates more particularly to devices, non-transitory computer-readable media, and methods for reducing data storage duplication through a multi-agent natural language processing loop.

### BACKGROUND

Large enterprises generate vast volumes of data relating to the enterprises' operations, customers, assets, and the like. Often, this data is stored across a plurality of storage locations (e.g., databases), which may be physically located together in a single location or distributed across multiple locations.

### SUMMARY

Devices, non-transitory computer-readable media, and methods for reducing data storage duplication through a multi-agent natural language processing loop are disclosed. An example method includes identifying, using a first natural language processing agent, a database of an enterprise containing desired data, selecting, using a second natural language processing agent, a schema analysis tool that is believed to be suited to a type of the database, establishing, using a third natural language processing agent, a connection to the database, extracting, using a fourth natural language processing agent, schema information from the database, comparing, using a fifth natural language processing agent and the schema analysis tool and based on the schema information, a structure of a schema of the database to a structure of a schema of a similar database, determining, based on the comparing, a change to make to the schema of the database, sending, using a sixth natural language processing agent, an instruction to a network element of the enterprise to make the change to the schema of the database, and validating, using a seventh natural language processing agent, the change to the schema information.

In another example, a non-transitory computer-readable medium stores instructions which, when executed by a processing system including at least one processor, cause the processing system to perform operations. The operations include identifying, using a first natural language processing agent, a database of an enterprise containing desired data, selecting, using a second natural language processing agent, a schema analysis tool that is believed to be suited to a type of the database, establishing, using a third natural language processing agent, a connection to the database, extracting, using a fourth natural language processing agent, schema information from the database, comparing, using a fifth natural language processing agent and the schema analysis tool and based on the schema information, a structure of a schema of the database to a structure of a schema of a similar database, determining, based on the comparing, a change to make to the schema of the database, sending, using a sixth natural language processing agent, an instruction to a network element of the enterprise to make the change to the schema of the database, and validating, using a seventh natural language processing agent, the change to the schema information.

In another example, a device includes a processing system including at least one processor and a non-transitory computer-readable medium. The non-transitory computer-readable medium stores instructions which, when executed by the processing system, cause the processing system to perform operations. The operations include identifying, using a first natural language processing agent, a database of an enterprise containing desired data, selecting, using a second natural language processing agent, a schema analysis tool that is believed to be suited to a type of the database, establishing, using a third natural language processing agent, a connection to the database, extracting, using a fourth natural language processing agent, schema information from the database, comparing, using a fifth natural language processing agent and the schema analysis tool and based on the schema information, a structure of a schema of the database to a structure of a schema of a similar database, determining, based on the comparing, a change to make to the schema of the database, sending, using a sixth natural language processing agent, an instruction to a network element of the enterprise to make the change to the schema of the database, and validating, using a seventh natural language processing agent, the change to the schema information.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for reducing data storage duplication through a multi-agent natural language processing loop may operate;

FIG. 2 illustrates a flowchart of an example method for reducing data storage duplication through a multi-agent natural language processing loop, in accordance with the present disclosure; and

FIG. 3 illustrates an example of a computing device, or computing system, specifically programmed to perform the steps, functions, blocks, and/or operations described herein.

To facilitate understanding, similar reference numerals have been used, where possible, to designate elements that are common to the figures.

### DETAILED DESCRIPTION

The present disclosure broadly discloses methods, computer-readable media, and systems for reducing data storage duplication through a multi-agent natural language processing loop. As discussed above, large enterprises generate vast volumes of data relating to the enterprises' operations, customers, assets, and the like Often, this data is stored across a plurality of storage locations (e.g., databases), which may be physically located together in a single location or distributed across multiple locations. The monetary costs of storing this data may represent a significant expenditure for an enterprise; thus, there is a need to ensure that data is being stored in an efficient manner so as not to waste resources.

Data duplication and inefficient data management, however, tend to be common in inventory databases, where, for example, a telecommunications network service provider may store data related to the provider's inventory of network devices. Storing the same data in multiple locations is wasteful and inefficient and can delay critical decision making. Moreover, duplicated data may be inconsistent and/or erroneous, which can further delay decision making as the decision makers strive to verify the accuracy of the data. For instance, inconsistent data stored across various provisioning databases and inventories has been shown to compromise the precision of strategic decisions, impact the quality of services provided to customers, and potentially contributed to disruptions of services.

Previous attempts to address database management, compare schema structures, and implement schema changes have been performed manually. Data analysts and administrators have meticulously reviewed the databases, identified duplicate data, and made manual schema adjustments. However, this approach is time consuming and prone to error, and, as such, data storage issues have persisted.

To mitigate the challenges of manual database management, some enterprises have employed ad-hoc scripting, custom software solutions, and/or database optimization tools. These solutions partially automate specific data management tasks, but tend to fall short of providing a comprehensive solution to database management. Moreover, custom software solutions require significant investments in development and maintenance and are typically designed to be enterprise-specific. Data optimization tools often require manual configuration and can be difficult to adapt to the structures of a specific enterprise.

Examples of the present disclosure employ a plurality of natural language processing (NLP) agents in a loop, combined with a central data storage, cloud databases, and specialized prompts, to provide an efficient and scalable solution to reducing data duplication in storage devices. The NLP agents may be equipped with advanced language models, and each NLP may be specifically programmed to perform a different, defined task or set of tasks related to database management (e.g., database identification, schema comparison, schema validation, or the like) with a high degree of accuracy. The language models utilized by the NLP agents may be trained to recognize and understand domain-specific information, recommend appropriate tools for completing tasks, and establish secure connections with other NLP agents. Thus, examples of the present disclosure significantly reduce the likelihood of human error that plagues manual database management methods and minimizes the risks of data duplication and inconsistency.

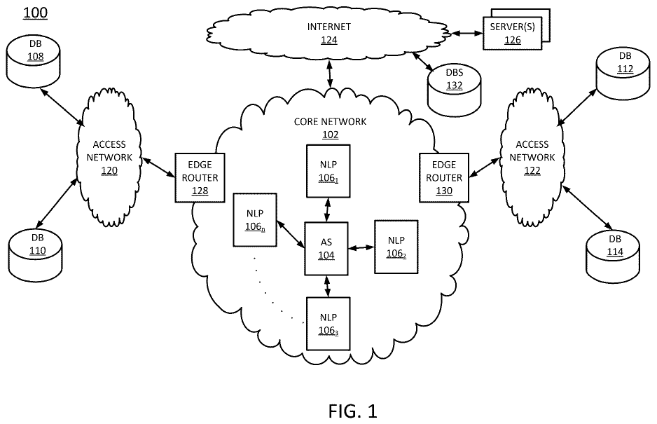

The central data storage eliminates the need for multiple disparate interfaces between different applications, streamlines communications, and minimizes data duplication. By consolidating data management in the central data storage, the overall efficiency of the database management effort can be enhanced through a more coordinated approach. These and other aspects of the present disclosure are discussed in greater detail below in connection with the examples of FIGS. 1-3.

To further aid in understanding the present disclosure, FIG. 1 illustrates an example system 100 in which examples of the present disclosure for reducing data storage duplication through a multi-agent natural language processing loop may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wired network, a wireless network, and/or a cellular network (e.g., 2G-5G, a long term evolution (LTE) network, and the like) related to the current disclosure. It should be noted that an IP network is broadly defined as a network that uses Internet Protocol to exchange data packets. Additional example IP networks include Voice over IP (VoIP) networks, Service over IP (SoIP) networks, the World Wide Web, and the like.

In one example, the system 100 may comprise a core network 102. The core network 102 may be in communication with one or more access networks, such as access networks 120 and 122, and with the Internet 124. In one example, the core network 102 may functionally comprise a fixed mobile convergence (FMC) network, e.g., an IP Multimedia Subsystem (IMS) network. In addition, the core network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. In one example, the core network 102 may include at least one application server (AS) 104, a plurality of natural language processing (NLP) agents 106₁-106ₙ (hereinafter individually referred to as an “NLP agent 106” or collectively referred to as “NLP agents 106”), and a plurality of edge routers 128-130. For ease of illustration, various additional elements of the core network 102 are omitted from FIG. 1.

In one example, the access networks 120 and 122 may comprise a Digital Subscriber Line (DSL) network, a public switched telephone network (PSTN) access network, a broadband cable access network, a Local Area Network (LAN), a wireless access network (e.g., an IEEE 802.11/Wi-Fi network and the like), a cellular access network, a 3^{rd} party network, and the like. In one example, the core network 102 may be operated by a telecommunication network service provider. The core network 102 and the access networks 120 and 122 may be operated by different service providers, the same service provider or a combination thereof, or the access networks 120 and 122 may be operated by an entity having a core business that is not related to telecommunications services, e.g., corporate, governmental, or educational institution LANs, and the like.

In one example, the access network 120 may be in communication with one or more data sources, such as databases (DBs) 108 and 110. The access network 120 may transmit and receive communications between the DBs 108 and 110, between the DBs 108 and 110 and the server(s) 126, the AS 104, other components of the core network 102, devices reachable via the Internet in general, and so forth. Similarly, the access network 122 may be in communication with one or more DBs 112 and 114. The access network 122 may transmit and receive communications between the DBs 112 and 114, between the DBs 112 and 114 and the server(s) 126, the AS 104, other components of the core network 102, devices reachable via the Internet in general, and so forth.

Each of the DBs 108, 110, 112, and 114 may be associated with a different system of an enterprise that generates data. For instance, if the enterprise is a telecommunications network service provider, one DB may store data relating to a troubleshooting and ticketing system, another DB may store data relating to subscriber billing, another DB may store data relating to network topology, and so on. Thus, at least two of the DBs 108, 110, 112, and 114 may store different types of data. These DBs 108, 110, 112, and 114 may be physically located in the same location or in different locations, and each DB 108, 110, 112, and 114 may store vast amounts of data.

In one example, the DBs 108, 110, 112, and 114 may be accessible to one or more servers 126 via the Internet 124 in general. Data such as the data stored in the DBs 108, 110, 112, and 114 may also be stored in DBs 132 that are accessible by the server(s) 126 and/or by the AS 104. The server(s) 126 may operate in a manner similar to the AS 104, which is described in further detail below.

In accordance with the present disclosure, the AS 104 and NLP agents 106 may be configured to provide one or more operations or functions in connection with examples of the present disclosure for reducing data storage duplication through a multi-agent natural language processing loop, as described herein. For instance, the AS 104 may be configured to formulate and issue prompts to the NLP agents 106 that cause the NLP agents 106 to perform specific tasks related to database management.

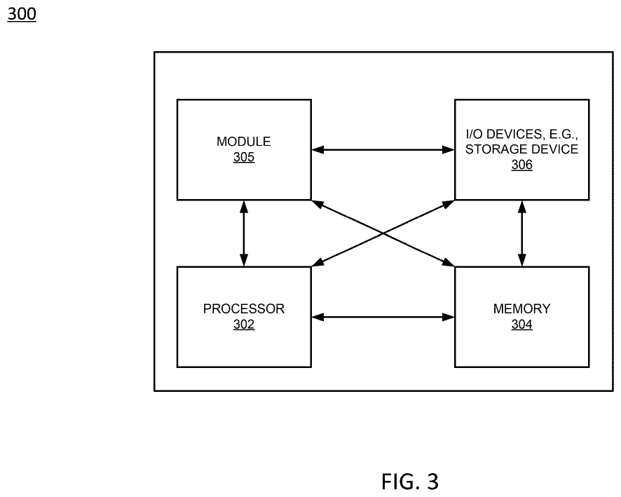

To this end, the AS 104 may comprise one or more physical devices, e.g., one or more computing systems or servers, such as computing system 300 depicted in FIG. 3, and may be configured as described below. The AS 104 may have access to at least some of the DBs 108, 110, 112, 114, and/or 132.

Each of the NLP agents 106 may comprise one or more physical devices, e.g., one or more computing systems or servers, such as computing system 300 depicted in FIG. 3, and may be configured as described below. Alternatively, each of the NLP agents 106 may comprise a software function executed by the AS 104. As described above, each NLP agent 106 may be programmed to perform a specific task related to database management, and may perform this specific task in response to prompts issued by the AS 104, where the prompts may be issued in natural language. Examples of specific database management related tasks that the NLP agents 106 may be programmed to perform include identifying databases (e.g., of the DBs 108, 110, 112, 114, and/or 132) containing desired or requested data, selecting schema analysis tools, establishing connections to databases (e.g., of the DBs 108, 110, 112, 114, and/or 132), extracting schema information from the databases (e.g., of the DBs 108, 110, 112, 114, and/or 132), comparing structures of schema of different databases (e.g., of the DBs 108, 110, 112, 114, and/or 132), sending instructions to change schemas of databases (e.g., of the DBs 108, 110, 112, 114, and/or 132), and validating changes to schemas of the databases (e.g., of the DBs 108, 110, 112, 114, and/or 132).

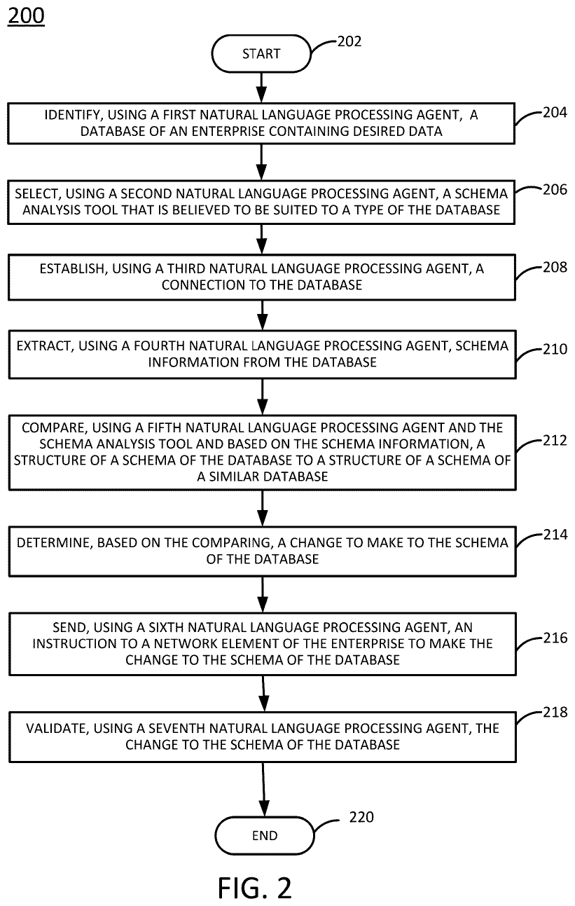

In one example, a physical storage device may be integrated with the AS 104 (e.g., a database server or a file server), or attached or coupled to the AS 104, in accordance with the present disclosure. In one example, the AS 104 may load instructions into a memory, or one or more distributed memory units, and execute the instructions for reducing data storage duplication through a multi-agent natural language processing loop, as described herein. Example methods for reducing data storage duplication through a multi-agent natural language processing loop are described in greater detail below in connection with FIG. 2.

It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure.

It should be noted that the system 100 has been simplified. Thus, those skilled in the art will realize that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. For example, the system 100 may include other network elements (not shown) such as border elements, routers, switches, policy servers, security devices, gateways, media streaming server, a content distribution network (CDN) and the like. For example, portions of the core network 102, access networks 120 and 122, and/or Internet 124 may comprise a content distribution network (CDN) having ingest servers, edge servers, and the like. Similarly, although only two access networks 120 and 122 are shown, in other examples, the access networks 120 and 122 may comprise a plurality of different access networks that may interface with the core network 102 independently or in a chained manner. For example, DBs 108-114 may communicate with the core network 102 via different access networks. Thus, these and other modifications are all contemplated within the scope of the present disclosure.

FIG. 2 illustrates a flowchart of an example method 200 for reducing data storage duplication through a multi-agent natural language processing loop, in accordance with the present disclosure. In one example, steps, functions and/or operations of the method 200 may be performed by a device as illustrated in FIG. 1, e.g., AS 104 or any one or more components thereof. In another example, the steps, functions, or operations of method 200 may be performed by a computing device or system 300, and/or a processing system 302 as described in connection with FIG. 3 below. For instance, the computing device 300 may represent at least a portion of the AS 104 in accordance with the present disclosure. For illustrative purposes, the method 200 is described in greater detail below in connection with an example performed by a processing system, such as processing system 302.

The method 200 begins in step 202 and proceeds to step 204. In step 204, the processing system may identify, using a first natural language processing agent, a database of an enterprise containing desired data.

In one example, the enterprise may comprise a business that stores vast amounts of data related to the business (e.g., data relating to operations, inventory, customers, etc.). The data may be stored in a plurality of databases, where the plurality of databases may be physically located in one common location or geographically distributed across multiple locations. As an example, the enterprise may comprise a telecommunications network service provider, and the plurality of databases may include databases that store data relating to customer accounts and billing, network elements and topography, troubleshooting and ticketing, and other types of data. The desired or requested data may be identified as data potentially having data duplication and inconsistency, e.g., inconsistent error codes from different equipment vendors for the same error, inconsistent resolution codes used by different organizations of an enterprise for the same resolution of a reported problem, different subscriber names for the same subscriber account, and so on.

The first NLP agent may comprise one of a plurality of NLP agents arranged in a loop, where each of the NLP agents performs a different function related to database management. To this end, each NLP agent may perform its respective function within a sentence or a particular semantic structure, which may be expressed in a prompt to the NLP agent.

Within the context of step 204, the first NLP agent may be programmed to identify and classify databases of the enterprise based on domain-specific information (e.g., information that is specific to the domain in which the enterprise operates, such as telecommunications networks or another domain). As an example, where the enterprise comprises a telecommunications network service provider, the first NLP agent may identify inventory databases which store inventory data for network devices. In this case, a prompt provided to the first NLP agent may specify, “List devices that are retired or not in use related to a network infrastructure” or “List databases with inventory information for network devices.”

In step 206, the processing system may select, using a second natural language processing agent, a schema analysis tool that is believed to be suited to a type of the database. In one example, the second NLP agent may be programmed to detect a type of the database that is identified in step 204 and may recommend a suitable schema analysis tool for analyzing a schema of the selected database. As an example, if the database is an inventory database, then the second NLP agent may select a schema analysis tool that optimizes inventory management and tracking, to ensure that the schema analysis aligns with the unique needs of the inventory database. Continuing the example where the enterprise is a telecommunications network service provider, a prompt provided to the second NLP agent may specify, “Select suitable schema analysis tools for inventory management databases” or “Recommend schema analysis tools for BRAND XYZ inventory databases.”

In step 208, the processing system may establish, using a third natural language processing agent, a connection to the database. In one example, the third NLP agent may be programmed to securely manage database credentials and automate connection processes. This ensures that data access and handling are efficient and secure, which is especially crucial when dealing with databases that contain sensitive information, such as equipment inventory. Continuing the example where the enterprise is a telecommunications network service provider, a prompt provided to the third NLP agent may specify, “Validate database credentials for User A in BRAND XYZ inventory databases” or “Automate the connection process for network infrastructure databases.”

In step 210, the processing system may extract, using a fourth natural language processing agent, schema information from the database. In one example, the fourth NLP agent may be programmed to efficiently parse schema information and identify domain-specific patterns and relationships in the schema of the database. For instance, the fourth NLP agent may recognize nuances of inventory data and optimize data extraction for more informed decision making. In this case, metadata may play an important role in storing the varieties of distinct data formats and terminologies associated with the data formats, which adds unique character to each of the data formats and highlights the importance of context-based and domain-specific information during schema information extraction. For example, in the domain of telecommunications networks, communications standards like “3GPP” (Third Generation Partnership Project) and “5G” (Fifth Generation) and technologies such as “GSM” (Global System for Mobile Communications) and “LTE” (Long Term Evolution), as well as different terminologies with unique domain-specific meanings such as “macro cell” and “small cell” may complicate extraction of schema information.

Continuing the example where the enterprise is a telecommunications network service provider, a prompt provided to the fourth NLP agent may specify, “Parse and analyze schema information for ABC databases” or “Identify domain-specific patterns in BRAND XYZ inventory schema objects.”

In step 212, the processing system may compare, using a fifth natural language processing agent and the schema analysis tool and based on the schema information, a structure of a schema of the database to a structure of a schema of a similar database.

In one example, the fifth NLP agent may be programmed to use the schema analysis tool and the schema information that is extracted in step 210 to perform precise schema comparisons which consider domain knowledge. The comparisons may compare the schema of the database to the schema of other similar databases (e.g., other databases of the same type, such as inventory databases), where the other similar databases may or may not be databases owned by the enterprise. For inventory databases, for instance, a comparison may consider the specific attributes and relationships related to inventory management. In one example, following the comparison, the fifth NLP agent may also perform a validation of pre-defined test standards.

Continuing the example where the enterprise is a telecommunications network service provider, a prompt provided to the fifth NLP agent may specify, “Conduct precise schema comparisons for ENTERPRISE X'S inventory data” or “Analyze differences between schema structures in network infrastructure databases.”

In step 214, the processing system may determine, based on the comparing, a change to make to the schema of the database. For instance, based on the comparison performed in step 212, the processing system may determine a specific change to make to the schema of the database. The change may improve the consistency of the schema of the database with schemas of other similar databases. In one example, the fifth NLP agent may also be programmed to determine the nature of the change to make to the schema of the database. In one example, another NLP agent may be used to determine the nature of the change.

In step 216, the processing system may send, using a sixth natural language processing agent, an instruction to a network element of the enterprise to make the change to the schema of the database. In one example, the sixth NLP agent may be programmed to automate schema changes. As an example, in any mobility database of a telecommunications network service provider, optimizing mobility radio access network (RAN) transport, converged schema, and enhanced equipment decommissioning cleanup may be automated by the sixth NLP agent with precision. Similarly, the sixth NLP agent may seamlessly handle tasks such as supporting sidehaul order automated cancellation and/or reissue and streamlining greenfield backhaul work order data automation.

Continuing the example where the enterprise is a telecommunications network service provider, a prompt provided to the sixth NLP agent may specify, “Automate schema changes for optimizing mobility RAN transport” or “Implement schema modifications for enhanced equipment decommissioning cleanup in BRAND XYZ inventory.”

In step 218, the processing system may validate, using a seventh natural language processing agent, the change to the schema information. In one example, the seventh NLP agent may be programmed to efficiently validate updated databases (e.g., databases whose schema have been changed). Specialized testing of the databases may ensure that any schema changes associated with, for instance, mobility, equipment decommissioning, or data automation (for an enterprise comprising a telecommunications network service provider) are rigorously validated.

Continuing the example where the enterprise is a telecommunications network service provider, a prompt provided to the seventh NLP agent may specify, “Validate schema changes for mobility database, sidehaul order automated cancellation/reissue” or “Efficiently test and validate greenfield backhaul work order data automation in mobility database.”

It should be noted that in some cases, if the seventh NLP agent cannot validate the change to the schema information, then the method 200 may return to step 214 and/or step 216, and the processor may issue a new prompt to the sixth NLP agent to send a new instruction to make a new or updated change to the schema of the database. Thus, in some examples, the method 200 may iterate through steps 214-218 until a change to the schema of the database can be validated.

The method 200 may end in step 220.

Thus, examples of the present disclosure utilize a processing system to issue specially tailored (e.g., tailored to the domain or context of a specific enterprise) natural language prompts to a loop of NLP agents which are programmed to perform different functions related to database management. By leveraging the artificial intelligence-driven NLP agents which are programmed to perform specialized tasks tailored to the needs of the enterprise's databases, data management can be streamlined, data duplication can be reduced, and service delivery applications can be optimized. Thus, data consistency is enhanced, allowing the enterprise to provide improved services to customers.

It should be noted that the method 200 may be expanded to include additional steps or may be modified to include additional operations, parameters, or scores with respect to the steps outlined above. In addition, although not specifically specified, one or more steps, functions, or operations of the method 200 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIG. 2 that recite a determining operation or involve a decision do not necessarily require that both branches of the determining operation be practiced. In other words, one of the branches of the determining operation can be deemed as an optional step. Furthermore, steps, blocks, functions or operations of the above described method can be combined, separated, and/or performed in a different order from that described above, without departing from the examples of the present disclosure.

FIG. 3 depicts a high-level block diagram of a computing device or processing system specifically programmed to perform the functions described herein. As depicted in FIG. 3, the processing system 300 comprises one or more hardware processor elements 302 (e.g., a central processing unit (CPU), a microprocessor, or a multi-core processor), a memory 304 (e.g., random access memory (RAM) and/or read only memory (ROM)), a module 305 for reducing data storage duplication through a multi-agent natural language processing loop, and various input/output devices 306 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computing device may employ a plurality of processor elements. Furthermore, although only one computing device is shown in the figure, if the method 200 as discussed above is implemented in a distributed or parallel manner for a particular illustrative example, i.e., the steps of the above method 200 or the entire method 200 is implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 302 can also be configured or programmed to cause other devices to perform one or more operations as discussed above. In other words, the hardware processor 302 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method 200. In one example, instructions and data for the present module or process 305 for reducing data storage duplication through a multi-agent natural language processing loop (e.g., a software program comprising computer-executable instructions) can be loaded into memory 304 and executed by hardware processor element 302 to implement the steps, functions, or operations as discussed above in connection with the illustrative method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 305 for reducing data storage duplication through a multi-agent natural language processing loop (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
identifying, by a processing system including at least one processor using a first natural language processing agent, a database of an enterprise containing desired data;
selecting, by the processing system using a second natural language processing agent, a schema analysis tool that is believed to be suited to a type of the database;
establishing, by the processing system using a third natural language processing agent, a connection to the database;
extracting, by the processing system using a fourth natural language processing agent, schema information from the database;
comparing, by the processing system using a fifth natural language processing agent and the schema analysis tool and based on the schema information, a structure of a schema of the database to a structure of a schema of a similar database;
determining, by the processing system based on the comparing, a change to make to the schema of the database;
sending, by the processing system using a sixth natural language processing agent, an instruction to a network element of the enterprise to make the change to the schema of the database; and
validating, by the processing system using a seventh natural language processing agent, the change to the schema.

2. The method of claim 1, wherein the database is one of a plurality of databases of the enterprise, and at least two databases of the plurality of databases store different types of information related to the enterprise.

3. The method of claim 1, wherein each of the first natural language processing agent, the second natural language processing agent, the third natural language processing agent, the fourth natural language processing agent, the fifth natural language processing agent, the sixth natural language processing agent, and the seventh natural language processing agent is programmed to perform a different function in response to a prompt issued by the processing system.

4. The method of claim 3, wherein the prompt is expressed in a natural language.

5. The method of claim 3, wherein the first natural language processing agent is programmed to identify and classify the database based on information that is specific to a domain of the enterprise.

6. The method of claim 3, wherein the second natural language processing agent is programmed to detect the type of the database and to recommend the schema analysis tool based on the type.

7. The method of claim 3, wherein the third natural language processing agent is programmed to manage database credentials and automate connection processes.

8. The method of claim 3, wherein the fourth natural language processing agent is programmed to parse the schema information and identify patterns and relationships in the schema of the database that are specific to a domain of the enterprise.

9. The method of claim 8, wherein the fourth natural language processing agent relies on metadata associated with the database to identify the patterns and relationships.

10. The method of claim 3, wherein the fifth natural language processing agent is programmed to perform schema comparisons which account for knowledge of a domain of the enterprise.

11. The method of claim 3, wherein the sixth natural language processing agent is programmed to automate schema changes.

12. The method of claim 3, wherein the seventh natural language processing agent is programmed to validate updated databases.

13. The method of claim 1, further comprising repeating the determining and the sending when the validating cannot be performed successfully.

14. The method of claim 1, wherein language models utilized by the first natural language processing agent, the second natural language processing agent, the third natural language processing agent, the fourth natural language processing agent, the fifth natural language processing agent, the sixth natural language processing agent, and the seventh natural language processing agent are trained to recognize and understand information that is specific to a domain of the enterprise.

15. A non-transitory computer-readable medium storing instructions which, when executed by a processing system including at least one processor, cause the processing system to perform operations, the operations comprising:
identifying, using a first natural language processing agent, a database of an enterprise containing desired data;
selecting, using a second natural language processing agent, a schema analysis tool that is believed to be suited to a type of the database;
establishing, using a third natural language processing agent, a connection to the database;
extracting, using a fourth natural language processing agent, schema information from the database;
comparing, using a fifth natural language processing agent and the schema analysis tool and based on the schema information, a structure of a schema of the database to a structure of a schema of a similar database;
determining, based on the comparing, a change to make to the schema of the database;
sending, using a sixth natural language processing agent, an instruction to a network element of the enterprise to make the change to the schema of the database; and
validating, using a seventh natural language processing agent, the change to the schema.

16. The non-transitory computer-readable medium of claim 15, wherein each of the first natural language processing agent, the second natural language processing agent, the third natural language processing agent, the fourth natural language processing agent, the fifth natural language processing agent, the sixth natural language processing agent, and the seventh natural language processing agent is programmed to perform a different function in response to a prompt issued by the processing system.

17. The non-transitory computer-readable medium of claim 16, wherein the prompt is expressed in a natural language.

18. The non-transitory computer-readable medium of claim 16, wherein language models utilized by the first natural language processing agent, the second natural language processing agent, the third natural language processing agent, the fourth natural language processing agent, the fifth natural language processing agent, the sixth natural language processing agent, and the seventh natural language processing agent are trained to recognize and understand information that is specific to a domain of the enterprise.

19. The non-transitory computer-readable medium of claim 15, the operations further comprising repeating the determining and the sending when the validating cannot be performed successfully.

20. A device comprising:
a processing system including at least one processor; and
a non-transitory computer-readable medium storing instructions which, when executed by the processing system, cause the processing system to perform operations, the operations comprising:
identifying, using a first natural language processing agent, a database of an enterprise containing desired data;
selecting, using a second natural language processing agent, a schema analysis tool that is believed to be suited to a type of the database;
establishing, using a third natural language processing agent, a connection to the database;
extracting, using a fourth natural language processing agent, schema information from the database;
comparing, using a fifth natural language processing agent and the schema analysis tool and based on the schema information, a structure of a schema of the database to a structure of a schema of a similar database;
determining, based on the comparing, a change to make to the schema of the database;
sending, using a sixth natural language processing agent, an instruction to a network element of the enterprise to make the change to the schema of the database; and
validating, using a seventh natural language processing agent, the change to the schema.
